(19) United States
(12) Patent Application Publication
(10) Pub. No.: US 2019/0371149 A1
(43) Pub. Date: Dec. 5, 2019

(54) APPARATUS AND METHOD FOR USER MONITORING

(71) Applicant: LG ELECTRONICS INC., Seoul (KR)

(72) Inventors: Hyunkyu KIM, Seoul (KR); Kibong SONG, Seoul (KR)

(73) Assignee: LG ELECTRONICS INC., Seoul (KR)

(21) Appl. No.: 16/541,597

(22) Filed: Aug. 15, 2019

(30) Foreign Application Priority Data
Jul. 3, 2019 (KR) 10-2019-0080153

(51) Int. Cl. G08B 21/02; G08B 31/00; G08B 13/196

(52) U.S. Cl. CPC G08B 21/0233; G08B 31/00; G08B 13/19604; G08B 21/0277; G08B 13/19606

(57) ABSTRACT

Provided are a user monitoring method and a user monitoring apparatus. The user monitoring method includes acquiring image information of an interior of a self-driving vehicle, monitoring information related to another user other than a preset user in the self-driving vehicle based on the acquired image information, determining a specific act potential for the preset user by the another user using an interaction potential prediction model trained based on the monitored related information, and performing a preset operation according to the determination of the specific act. One or more of a self-driving vehicle and a user monitoring apparatus of the present invention may be in conjunction with Artificial Intelligence (AI), Unmanned Aerial Vehicle (UAV), a robot, an Augmented Reality (AR) device, a Virtual Reality (VR) device, and a 5G service.

### CROSS-REFERENCE TO RELATED APPLICATION

Pursuant to 35 U.S.C. § 119(a), this application claims the benefit of earlier filing date and right of priority to Korean Patent Application No. 10-2019-0080153, filed on Jul. 3, 2019, the contents of which are hereby incorporated by reference herein in its entirety.

### BACKGROUND OF THE INVENTION

### Field of the Invention

The present disclosure relates to a user monitoring method and a user monitoring apparatus, and more specifically to a user monitoring method and a user monitoring apparatus, by which an operation corresponding to a crime potential against a preset user by another user can be performed.

### Related Art

Due to declining family formation and falling birth rates, an average number of young children in a household is one or two and the need of protection of young children is growing. In addition, as crimes against young children increase, there are increasing demands for technologies to protect young children outside. In particular, since many crimes happens while a young child alone goes to school and comes back home after school, parents' concerns are growing and demands more technology for ensuring young children's safety. Thus, it is necessary to develop a technology for protecting a young child from any crime potential in a predetermined space such as a vehicle.

### SUMMARY OF THE INVENTION

Provided are a user monitoring method and a user monitoring apparatus, by which an operation corresponding to a crime potential against a preset user (e.g., a young child) by another user can be performed. However, the technical goal of the present disclosure is not limited thereto, and other technical goals may be inferred from the following embodiments.

A user monitoring method according to an embodiment of the present invention includes: acquiring image information of an interior of a self-driving vehicle; monitoring information related to another user other than a preset user in the self-driving vehicle based on the acquired image information; determining a specific act potential for the preset user by the another user using an interaction potential prediction model trained based on the monitored related information; and performing a preset operation according to the determination of the specific act.

A user monitoring apparatus according to another embodiment of the present invention includes: a sensor configured to acquire image information; and a processor configured to monitor information related to another user related to a preset user based on the acquired image information, determine a specific act potential for the preset user by the another user using an interaction potential prediction model trained based on the monitored related information, and perform a preset operation according to the determination of the specific act potential.

Details of other embodiments are included in the detailed description and the attached drawings.

According to embodiments of the present invention, there are one or more advantageous effects as below.

First, a user located in a predetermined space such as a vehicle can be monitored, thereby ensuring safety of a preset user.

Second, a crime potential for the preset user can be determined based on information (e.g., a personal trait) related to the preset user, thereby protecting the preset user more safely.

Third, information related to another user other than the preset user can be monitored and a crime potential can be determined based on the monitoring information, thereby protecting the preset user more safely.

Effects of the present invention are not limited to the above disclosed effects, and other effects of the present invention which are not disclosed herein will be clearly understood from the accompanying claims by those skilled in the art.

### BRIEF DESCRIPTION OF THE DRAWINGS

FIG. 1 shows an artificial intelligence (AI) device according to an embodiment of the present invention.

FIG. 2 shows an AI server according to an embodiment of the present invention.

FIG. 3 shows an AI system according to an embodiment of the present invention.

FIG. 4 is an example of a user monitoring method for determining a specific act potential for an occupant preset by another occupant present in a vehicle using a user monitoring apparatus according to an embodiment of the present invention.

FIG. 5 is a diagram showing an example of a user monitoring method for determining a specific act potential for an occupant preset by another occupant present in a vehicle using a user monitoring apparatus according to another embodiment of the present invention.

FIG. 6 is a diagram showing an example of a user monitoring method for determining a specific act potential for an occupant preset by another occupant present in a vehicle using a user monitoring apparatus according to yet another embodiment of the present invention.

FIG. 7 is a block diagram of a user monitoring apparatus according to an embodiment of the present invention.

FIG. 8 is a flowchart of a user monitoring method by use of a user monitoring apparatus according to an embodiment of the present invention.

FIG. 9 is a diagram showing how to change a specific act potential depending on a previous record and outer appearance of another user other than a preset user according to an embodiment of the present invention.

FIG. 10 is a diagram showing how to change a specific act potential by reflecting information related to a preset user according to an embodiment of the present invention.

### DESCRIPTION OF EXEMPLARY EMBODIMENTS

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Exemplary embodiments of the present invention are described in detail with reference to the accompanying drawings. Detailed descriptions of technical specifications well-known in the art and unrelated directly to the present invention may be omitted to avoid obscuring the subject matter of the present invention. This aims to omit unnecessary description so as to make clear the subject matter of the present invention. For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers. Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification. It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams. Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions. According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card. In addition, a controller mentioned in the embodiments may include at least one processor that is operated to control a corresponding apparatus.

Artificial Intelligence refers to the field of studying artificial intelligence or a methodology capable of making the artificial intelligence. Machine learning refers to the field of studying methodologies that define and solve various problems handled in the field of artificial intelligence. Machine learning is also defined as an algorithm that enhances the performance of a task through a steady experience with respect to the task.

An artificial neural network (ANN) is a model used in machine learning, and may refer to a general model that is composed of artificial neurons (nodes) forming a network by synaptic connection and has problem solving ability. The artificial neural network may be defined by a connection pattern between neurons of different layers, a learning process of updating model parameters, and an activation function of generating an output value.

The artificial neural network may include an input layer and an output layer, and may selectively include one or more hidden layers. Each layer may include one or more neurons, and the artificial neural network may include a synapse that interconnects neurons. In the artificial neural network, each neuron may output input signals that are input through the synapse, weights, and the value of an activation function concerning deflection.

Model parameters refer to parameters determined by learning, and include weights for synaptic connection and deflection of neurons, for example. Then, hyper-parameters mean parameters to be set before learning in a machine learning algorithm, and include a learning rate, the number of repetitions, the size of a mini-batch, and an initialization function, for example.

It can be said that the purpose of learning of the artificial neural network is to determine a model parameter that minimizes a loss function. The loss function maybe used as an index for determining an optimal model parameter in a learning process of the artificial neural network.

Machine learning may be classified, according to a learning method, into supervised learning, unsupervised learning, and reinforcement learning.

The supervised learning refers to a learning method for an artificial neural network in the state in which a label for learning data is given. The label may refer to a correct answer (or a result value) to be deduced by an artificial neural network when learning data is input to the artificial neural network. The unsupervised learning may refer to a learning method for an artificial neural network in the state in which no label for learning data is given. The reinforcement learning may mean a learning method in which an agent defined in a certain environment learns to select a behavior or a behavior sequence that maximizes cumulative compensation in each state.

Machine learning realized by a deep neural network (DNN) including multiple hidden layers among artificial neural networks is also called deep learning, and deep learning is a part of machine learning. Hereinafter, machine learning is used as a meaning including deep learning.

The term “autonomous driving” refers to a technology of autonomous driving, and the term “autonomous vehicle” refers to a vehicle that travels without a user's operation or with a user's minimum operation.

For example, autonomous driving may include all of a technology of maintaining the lane in which a vehicle is driving, a technology of automatically adjusting a vehicle speed such as adaptive cruise control, a technology of causing a vehicle to automatically drive along a given route, and a technology of automatically setting a route, along which a vehicle drives, when a destination is set.

A vehicle may include all of a vehicle having only an internal combustion engine, a hybrid vehicle having both an internal combustion engine and an electric motor, and an electric vehicle having only an electric motor, and may be meant to include not only an automobile but also a train and a motorcycle, for example.

At this time, an autonomous vehicle may be seen as a robot having an autonomous driving function.

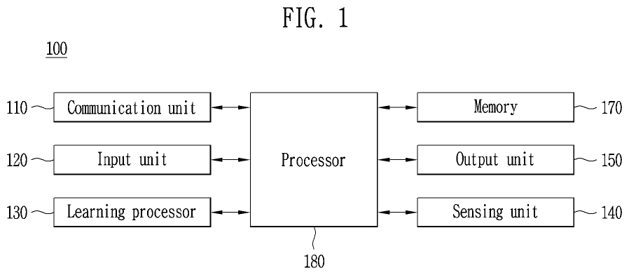

FIG. 1 illustrates an AI device 100 according to an embodiment of the present disclosure.

AI device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, or a vehicle.

Referring to FIG. 1, Terminal 100 may include a communication unit 110, an input unit 120, a learning processor 130, a sensing unit 140, an output unit 150, a memory 170, and a processor 180, for example.

Communication unit 110 may transmit and receive data to and from external devices, such as other AI devices 100a to 100e and an AI server 200, using wired/wireless communication technologies. For example, communication unit 110 may transmit and receive sensor information, user input, learning models, and control signals, for example, to and from external devices.

At this time, the communication technology used by communication unit 110 may be, for example, a global system for mobile communication (GSM), code division multiple Access (CDMA), long term evolution (LTE), 5G wireless LAN (WLAN), wireless-fidelity (Wi-Fi), Bluetooth™, radio frequency identification (RFID), infrared data association (IrDA), ZigBee, or near field communication (NFC).

Input unit 120 may acquire various types of data.

At this time, input unit 120 may include a camera for the input of an image signal, a microphone for receiving an audio signal, and a user input unit for receiving information input by a user, for example. Here, the camera or the microphone may be handled as a sensor, and a signal acquired from the camera or the microphone may be referred to as sensing data or sensor information.

Input unit 120 may acquire, for example, input data to be used when acquiring an output using learning data for model learning and a learning model. Input unit 120 may acquire unprocessed input data, and in this case, processor 180 or learning processor 130 may extract an input feature as pre-processing for the input data.

Learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

At this time, learning processor 130 may perform AI processing along with a learning processor 240 of AI server 200.

At this time, learning processor 130 may include a memory integrated or embodied in AI device 100. Alternatively, learning processor 130 may be realized using memory 170, an external memory directly coupled to AI device 100, or a memory held in an external device.

Sensing unit 140 may acquire at least one of internal information of AI device 100 and surrounding environmental information and user information of AI device 100 using various sensors.

At this time, the sensors included in sensing unit 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar, for example.

Output unit 150 may generate, for example, a visual output, an auditory output, or a tactile output.

At this time, output unit 150 may include, for example, a display that outputs visual information, a speaker that outputs auditory information, and a haptic module that outputs tactile information.

Memory 170 may store data which assists various functions of AI device 100. For example, memory 170 may store input data acquired by input unit 120, learning data, learning models, and learning history, for example.

Processor 180 may determine at least one executable operation of AI device 100 based on information determined or generated using a data analysis algorithm or a machine learning algorithm. Then, processor 180 may control constituent elements of AI device 100 to perform the determined operation.

To this end, processor 180 may request, search, receive, or utilize data of learning processor 130 or memory 170, and may control the constituent elements of AI device 100 so as to execute a predictable operation or an operation that is deemed desirable among the at least one executable operation.

At this time, when connection of an external device is necessary to perform the determined operation, processor 180 may generate a control signal for controlling the external device and may transmit the generated control signal to the external device.

Processor 180 may acquire intention information with respect to user input and may determine a user request based on the acquired intention information.

At this time, processor 180 may acquire intention information corresponding to the user input using at least one of a speech to text (STT) engine for converting voice input into a character string and a natural language processing (NLP) engine for acquiring natural language intention information.

At this time, at least a part of the STT engine and/or the NLP engine may be configured with an artificial neural network learned according to a machine learning algorithm. Then, the STT engine and/or the NLP engine may have learned by learning processor 130, may have learned by learning processor 240 of AI server 200, or may have learned by distributed processing of processors 130 and 240.

Processor 180 may collect history information including, for example, the content of an operation of AI device 100 or feedback of the user with respect to an operation, and may store the collected information in memory 170 or learning processor 130, or may transmit the collected information to an external device such as AI server 200. The collected history information may be used to update a learning model.

Processor 180 may control at least some of the constituent elements of AI device 100 in order to drive an application program stored in memory 170. Moreover, processor 180 may combine and operate two or more of the constituent elements of AI device 100 for the driving of the application program.

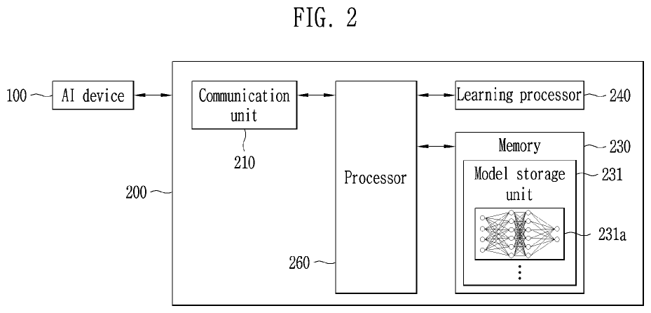

FIG. 2 illustrates AI server 200 according to an embodiment of the present disclosure.

Referring to FIG. 2, AI server 200 may refer to a device that causes an artificial neural network to learn using a machine learning algorithm or uses the learned artificial neural network. Here, AI server 200 may be constituted of multiple servers to perform distributed processing, and may be defined as a 5G network. At this time, AI server 200 may be included as a constituent element of AI device 100 so as to perform at least a part of AI processing together with AI device 100.

AI server 200 may include a communication unit 210, a memory 230, a learning processor 240, and a processor 260, for example.

Communication unit 210 may transmit and receive data to and from an external device such as AI device 100.

Memory 230 may include a model storage unit 231. Model storage unit 231 may store a model (or an artificial neural network) 231a which is learning or has learned via learning processor 240.

Learning processor 240 may cause artificial neural network 231a to learn learning data. A learning model may be used in the state of being mounted in AI server 200 of the artificial neural network, or may be used in the state of being mounted in an external device such as AI device 100.

The learning model may be realized in hardware, software, or a combination of hardware and software. In the case in which a part or the entirety of the learning model is realized in software, one or more instructions constituting the learning model may be stored in memory 230.

Processor 260 may deduce a result value for newly input data using the learning model, and may generate a response or a control instruction based on the deduced result value.

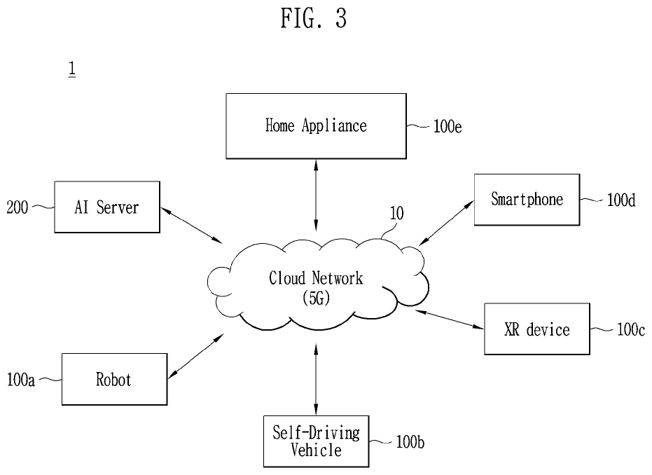

FIG. 3 illustrates an AI system 1 according to an embodiment of the present disclosure.

Referring to FIG. 3, in AI system 1, at least one of AI server 200, a robot 100a, an autonomous driving vehicle 100b, an XR device 100c, a smart phone 100d, and a home appliance 100e is connected to a cloud network 10. Here, robot 100a, autonomous driving vehicle 100b, XR device 100c, smart phone 100d, and home appliance 100e, to which AI technologies are applied, may be referred to as AI devices 100a to 100e.

Cloud network 10 may constitute a part of a cloud computing infra-structure, or may mean a network present in the cloud computing infra-structure. Here, cloud network 10 may be configured using a 3G network, a 4G or long term evolution (LTE) network, or a 5G network, for example.

That is, respective devices 100a to 100e and 200 constituting AI system 1 may be connected to each other via cloud network 10. In particular, respective devices 100a to 100e and 200 may communicate with each other via a base station, or may perform direct communication without the base station.

AI server 200 may include a server which performs AI processing and a server which performs an operation with respect to big data.

AI server 200 may be connected to at least one of robot 100a, autonomous driving vehicle 100b, XR device 100c, smart phone 100d, and home appliance 100e, which are AI devices constituting AI system 1, via cloud network 10, and may assist at least a part of AI processing of connected AI devices 100a to 100e.

At this time, instead of AI devices 100a to 100e, AI server 200 may cause an artificial neural network to learn according to a machine learning algorithm, and may directly store a learning model or may transmit the learning model to AI devices 100a to 100e.

At this time, AI server 200 may receive input data from AI devices 100a to 100e, may deduce a result value for the received input data using the learning model, and may generate a response or a control instruction based on the deduced result value to transmit the response or the control instruction to AI devices 100a to 100e.

Alternatively, AI devices 100a to 100e may directly deduce a result value with respect to input data using the learning model, and may generate a response or a control instruction based on the deduced result value.

Hereinafter, various embodiments of AI devices 100a to 100e, to which the above-described technology is applied, will be described. Here, AI devices 100a to 100e illustrated in FIG. 3 may be specific embodiments of AI device 100 illustrated in FIG. 1.

Autonomous driving vehicle 100b may be realized into a mobile robot, a vehicle, or an unmanned air vehicle, for example, through the application of AI technologies.

Autonomous driving vehicle 100b may include an autonomous driving control module for controlling an autonomous driving function, and the autonomous driving control module may mean a software module or a chip realized in hardware. The autonomous driving control module may be a constituent element included in autonomous driving vehicle 100b, but may be a separate hardware element outside autonomous driving vehicle 100b so as to be connected to autonomous driving vehicle 100b.

Autonomous driving vehicle 100b may acquire information on the state of autonomous driving vehicle 100b using sensor information acquired from various types of sensors, may detect (recognize) the surrounding environment and an object, may generate map data, may determine a movement route and a driving plan, or may determine an operation.

Here, autonomous driving vehicle 100b may use sensor information acquired from at least one sensor among a lidar, a radar, and a camera in the same manner as robot 100a in order to determine a movement route and a driving plan.

In particular, autonomous driving vehicle 100b may recognize the environment or an object with respect to an area outside the field of vision or an area located at a predetermined distance or more by receiving sensor information from external devices, or may directly receive recognized information from external devices.

Autonomous driving vehicle 100b may perform the above-described operations using a learning model configured with at least one artificial neural network. For example, autonomous driving vehicle 100b may recognize the surrounding environment and the object using the learning model, and may determine a driving line using the recognized surrounding environment information or object information. Here, the learning model may be directly learned in autonomous driving vehicle 100b, or may be learned in an external device such as AI server 200.

At this time, autonomous driving vehicle 100b may generate a result using the learning model to perform an operation, but may transmit sensor information to an external device such as AI server 200 and receive a result generated by the external device to perform an operation.

Autonomous driving vehicle 100b may determine a movement route and a driving plan using at least one of map data, object information detected from sensor information, and object information acquired from an external device, and a drive unit may be controlled to drive autonomous driving vehicle 100b according to the determined movement route and driving plan.

The map data may include object identification information for various objects arranged in a space (e.g., a road) along which autonomous driving vehicle 100b drives. For example, the map data may include object identification information for stationary objects, such as streetlights, rocks, and buildings, and movable objects such as vehicles and pedestrians. Then, the object identification information may include names, types, distances, and locations, for example.

In addition, autonomous driving vehicle 100b may perform an operation or may drive by controlling the drive unit based on user control or interaction. At this time, autonomous driving vehicle 100b may acquire interactional intention information depending on a user operation or voice expression, and may determine a response based on the acquired intention information to perform an operation.

An apparatus for user monitoring according to an embodiment of the present invention may be included inside/outside a self-driving vehicle by employ an AI technology. In addition, a crime potential anticipated in an embodiment may be, but not limited to, information related to an actual felony and may include a potential to perform a specific act set by a user or a potential to perform a specific act related to a young young child. In an embodiment, a specific act potential may indicate a potential to perform a specific act and a potential to commit a crime.

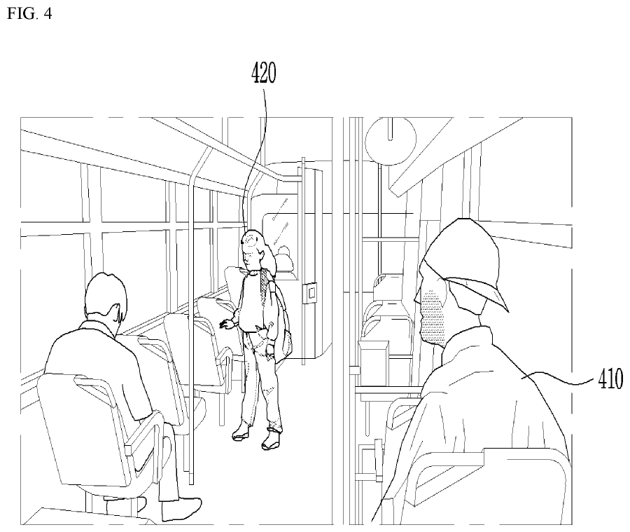

FIG. 4 is an example of a user monitoring method for determining a specific act potential for an occupant preset by another occupant present in a vehicle using a user monitoring apparatus according to an embodiment of the present invention.

The user monitoring apparatus may include a memory including computer readable instructions, and a processor for executing the instructions. A sensor for monitoring the interior of a self-driving vehicle may be embedded in the user monitoring apparatus or measured information may be received from the sensor by the user monitoring apparatus. In an embodiment, in-vehicle monitoring may be performed based on at least one of image information or sound information acquired by the processor. In an embodiment, at least one of the image information or the sound information may be acquired repeatedly, and the processor may monitor the interior of the vehicle based on at least one of the image information or the sound information. In an embodiment, based on a determination, the processor may change a frequency of acquiring at least one of the image information or the sound information. In addition, the processor may determine a frequency of acquiring one of the image information and the sound information, based on at least one of a monitoring time, a position of the vehicle, or the number of users present inside the vehicle.

According to an embodiment, at least one user may be present in the self-driving vehicle. At this point, a preset user may exist in users present in the vehicle. Here, the preset user may be a user designated in advance through an external server of the self-driving vehicle. For example, a parent may set a young child in advance through the external server and, in a case where the young child gets on the self-driving vehicle to go to school and go home after school, a sensor may recognize the young child. Here, the external server, which is a server for providing a service for estimating a specific act potential for the preset user, may transmit a notification to a designated user. In an embodiment, a target user is described as a young child but it is not limited thereto, and a user to be recognized may be determined based on at least one of setting by the user or a determination by the processor.

In the self-driving vehicle, another user may be present in addition to a preset user. At this point, most of other users present in the vehicle may be less likely to commit a crime against the preset user, but some of the users may be likely to commit a crime against the preset user.

Based on the image information and/or the sound information of the interior of the vehicle, which are acquired by the sensor, the processor may monitor information related to another user 410 present in the self-driving vehicle. Specifically, the processor may track a gaze of the another user 410 to thereby monitor whether the another user 410 gazes at a preset user 420 (e.g., a young child). Using an interaction potential prediction model, the processor embedded in the user monitoring apparatus may determine a crime potential for the another user 410 against a young child 420 and may perform a preset operation according to the determination. Here, the crime potential may be, but not limited thereto, information related to an actual felony and may include a potential to perform a specific act set by a user or a potential to perform a specific act associated with the young child. For example, in a case where a parent sets any contact with face of the young child 420, contact of the another user 410 with the face of the young child 420 may be determined as a specific act potential.

At this point, a result of the determination may be, for example, classified as “safe”/“alerting”/“dangerous” or may be classified as a further detailed state. For example, if the another user 410 present in the self-driving vehicle is doing a normal act, such as using a user terminal, the user monitoring apparatus may determine a specific act potential as safe. Alternatively, in a case where the another user 410 present in the self-driving vehicle keeps gazing at the young child 420 or speaks a swear word, the user monitoring apparatus may determine a specific act potential as “alerting”. In an embodiment, determining the normal act may be performed by the processor based on at least one of preset information or statistical information on behaviors of users present in the self-driving vehicle.

Alternatively, if contact with the young child 420 by the another user 410, which determined as “alerting”, occurs, the user monitoring apparatus may determine a specific act potential as “dangerous”. At this point, the determined specific act potential may be changed according to interaction between the another user 410 and the young child 420, reflection of information related to the young child 420, and a previous history of the another user 410. The change of the determined specific act potential will be hereinafter described in detail with reference to other drawings. If the specific act potential is determined as safe, the user monitoring apparatus may not transmit a notification to a designated user; if the specific act potential is determined as “alerting”, the user monitoring apparatus may transmit a notification to the designated user (e.g., the young child and the parent); or, if the specific act potential is determined as “dangerous”, the user monitoring apparatus may transmit a notification not just to the designated user (e.g., the young child or the parent) but also to a police station and the self-driving vehicle and the self-driving vehicle may display “dangerous” through an internal/external display in response to reception of the notification. In an embodiment, the self-driving vehicle may be determined based on one of information on the current position of the vehicle, information on the young child, and information on the parent.

Specifically, in a case where the another user 410 gazes at the young child 420, the processor may monitor the number of times the another user 410 gazes the young child 420 and/or a time period in which the another user 410 gazes the young child 420. That is, the processor may monitor whether the number of times the another user 410 gazes the young child 420 is greater than the number of times the another user 410 gazes a different occupant present in the self-driving vehicle, may monitor a time period in which the another user 410 gazes the young child 420, or may monitor an increase/decrease in the number of times the another user 410 gazes the young child 420 for a predetermined time period.

For example, when it is determined that the number of times the another user 410 gazes the young child 420 is greater than the number of times the another user 410 gazes a different occupant present in the self-driving vehicle and/or that the time period in which the another user 410 gazes the young child 420 is equal to or greater than a predetermined reference level and/or that the number of times the different user 410 gazes the young child 420 for the predetermined time period increases, the user monitoring apparatus may perform an operation corresponding to “alerting” or “dangerous”. In another example, when it is determined that the number of times the another user 410 gazes the young child 420 is smaller than the number of times the another user 410 gazes a different occupant present in the self-driving vehicle and/or that the time period in which the another user 410 gazes the young child 420 is equal to or less than a predetermined reference level and/or that the number of times the different user 410 gazes the young child 420 for the predetermined time period decreases, the user monitoring apparatus may perform an operation corresponding to “safe”.

In addition, the processor may monitor whether the another user 410 changes his/her facial expression while gazing the young child 420 and/or whether the another user 410 takes a specific act while gazing at the young child 420. For example, whether the another user 410 hardens his/her faces while gazing the young child 420 or makes a smile and/or whether the another user 410 takes a specific act (e.g., threatening) while gazing the young child 420 may be monitored and the user monitoring apparatus may perform preset operations corresponding to the respective cases.

In addition, based on a previous record inquired through the face of the another user 410, the user monitoring apparatus may determine a specific act potential. Here, the inquired previous record may include a crime record. For example, the user monitoring apparatus may determine specific act probabilities for the same behavior when the another user 410 having a crime record gazes the young child 420 and when the another user 410 having no crime record gazes the young child 410.

Here, the interaction potential prediction model may be previously trained through a Deep Neural Network (DNN), which is an example of deep learning, and may be updated based on monitoring-related information. Thus, using the updated interaction potential prediction model, the user monitoring apparatus may determine a specific act potential for a user 420 preset by the another user 410 present in the self-driving vehicle.

In an embodiment, the self-driving vehicle is an example of a specific space and the user monitoring method may apply to a user in the specific space in which a monitoring target is present. Thus, the specific space may be a predetermined area in a building or may include a predetermined area regarding which image information and/or sound information can be acquired.

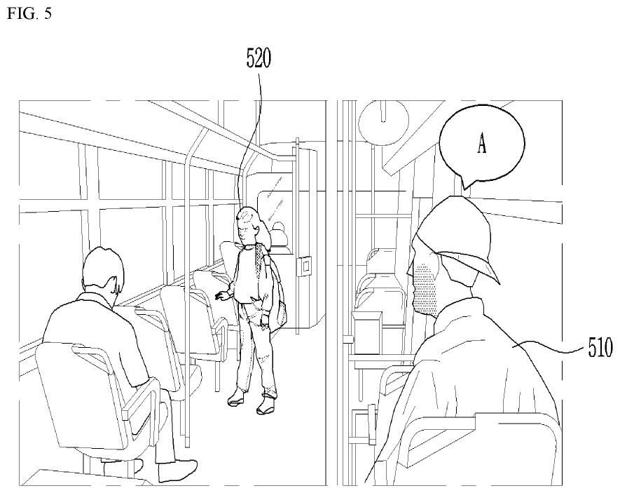

FIG. 5 is a diagram showing an example of a user monitoring method for determining a specific act potential for an occupant preset by another occupant present in a vehicle using a user monitoring apparatus according to another embodiment of the present invention. The above description about the user monitoring apparatus may apply to the user monitoring apparatus shown in FIG. 5.

One or more users may be present in a self-driving vehicle. At this point, a preset user may exist among the users present in the vehicle. Here, the preset user may be a user designated in advance through an external server of the self-driving vehicle. For example, a parent may preset a young child through the external server of the self-driving vehicle, and, when the young child gets on the self-driving vehicle to go to school and go home after school, a sensor may recognize the young child. Here, the external server of the self-driving vehicle, which is a server for providing a service that predicts a specific act potential for the preset user, may transmit a notification to the designated user. In an embodiment, the target user is described as a young child but it is not limited thereto, and a user to be recognized may be determined based on at least one of a setting of the user or determination of a processor.

In the self-driving vehicle, another user may be present in addition to the preset user. In this case, most of other users present in the vehicle may be less likely to commit a crime against the preset user, but some of the users may be likely to commit a crime against the preset user.

Based on image information and/or sound information of the interior of the vehicle, which is acquired by the sensor, the processor may monitor information related to another vehicle 510 present in the self-driving vehicle. Specifically, the processor may monitor a language used by another user 510 based on the acquired sound information. Based on information on the language of the another user 510, a processor embedded in the user monitoring apparatus may determine may determine a specific act potential for a user 520 (e.g., a young child) preset by the another user 510 using an interaction potential prediction model and may perform a preset operation according to a determination. Here, a crime potential may be, but not limited to, information related to an actual felony and may include a potential to perform a specific act set by a user or a potential to perform a specific act associated with a young child. In an embodiment, a specific act potential may indicate a potential to perform a specific act and a potential to commit a crime. For example, in a case where the parent presets use of a swear word toward a young child 520, if the language used by the another user 510 contains the swear word toward the young child 520, it is determined that there is a specific act potential.

At this point, the above description may apply to an operation according to the determination and change of the determined specific act potential. Here, the interaction potential prediction model may be previously trained through a Deep Neural Network (DNN), which is an example of deep learning, and may be updated based on monitoring-related information.

Specifically, based on the language of the another user 510, the processor embedded in the user monitoring apparatus may determine whether any swear word is included in the language and/or a frequency of a swear word. The user monitoring apparatus may extract a feature vector of a word included in the language used by the another user 510, extract multiple words corresponding to the extracted feature vector from a database, and determine whether the extracted multiple words and words included in the language used by the another user 510 are swear words stored in a swearword database to thereby determine whether a swear word is included in the language used by the another user 510. In addition, a user monitoring apparatus may determine not just whether any swear word is included in the language used by the another user 510, but also a frequency of a used swear word.

For example, the processor may monitor language “A” used by the another user 510 present in the self-driving vehicle, and the user monitoring apparatus may extract a feature vector (e.g., a1, a2, a3, . . . ) of a word included in the language used by the another user 510, extract multiple words (e.g., A1, A2, A3, . . . ) corresponding to the extracted feature vector (e.g., a1, a2, a3, . . . ) from a database, may determine whether the multiple words and a word included in the language used by the another user 510 correspond to a swear word included in a swear word database. Thus, although not found whether any swearword corresponding to the language “A” used by the another user 510 is included, the user monitoring apparatus may search for a swear word through the extracted multiple words (e.g., A1, A2, A3, . . . ) and thereby determine whether the swearword is a newly invented swear word. If a word included in the language used by the another user 510 is determined to correspond to a swear word, the user monitoring apparatus may check a frequency of the swear word and perform an operation corresponding to “alerting” or “dangerous”. If a word included in the language used by the another user 510 does not correspond to a swear word, the user monitoring apparatus may perform an operation corresponding to “safe”.

In addition, the user monitoring apparatus may determine whether the language used by the another user 510 includes information on the preset user 520. The user monitoring apparatus may analyze a word and/context included in the language used by the another user 510 to thereby determine whether the language includes information on the preset user 520 and, if so, determine whether contents of the corresponding language is positive or negative. Thus, the user monitoring apparatus may analyze the language used by the another user 510 to thereby estimate a specific act potential (e.g., a crime potential) for a young child 520 by the another user 510. Specifically, the user monitoring apparatus may analyze a word and context included in the language “A” used by the another user 510. The user monitoring apparatus may analyze whether the word and the context included in the language “A” indicates the young child 520 and may analyze whether the language “A” contains positive or negative contents about the young child 520. The user monitoring apparatus may determine a specific act potential for the young child 520 by the another user 510 based on the analysis of the language “A” and the user monitoring apparatus may perform a preset operation corresponding to the determination.

For example, if a word and/or context included in the language “A” used by the another user 510 is analyzed to thereby determine that a word indicating a characteristic of the young child 520 is included in the language “A” and that a content indicating negative context such as kidnapping/abduction/violence related to the young child 520 is included in the language “A”, the user monitoring apparatus may perform a preset operation corresponding to “alerting” or “dangerous” that is determined.

In addition, in a case where a word indicating the young child 520 is included in the language “A” used by the another user 510, the user monitoring apparatus may monitor whether the another user 510 changes his/her facial expression while gazing the young child 520 and or whether the another user 510 takes a specific act while gazing at the young child 520. For example, if a word indicating the young child 520 is included in the language “A” used by the another user 510, the user monitoring apparatus may monitor whether the another user 510 hardens his/her faces while gazing the young child 520 or makes a smile and/or whether the another user 510 takes a specific act (e.g., threatening) while gazing the young child 520, and the user monitoring apparatus may perform preset operations corresponding to the respective cases.

In addition, the user monitoring apparatus may estimate a specific act potential by reflecting interaction between the another user 510 and the young child 520. If the another user 510 attempt to talk with the young child 520, the specific act potential may be determined as “alerting” or “dangerous”, but, if conversation between the another user 510 and the young child is analyzed and determined as normal conversation, the specific act potential may be determined as safe. However, even though the conversation between the another user and the young child corresponds to normal conversation, if the another user 510 makes physical contact directly with the young child or the interaction lasts for more than a predetermined time, the specific act potential may be determined as “alerting” or “dangerous”. More specifically, the user monitoring apparatus may estimate a specific act potential according to the interaction, by reflecting information related to the young child 520. For example, if the young child 520 is introvert or has a social anxiety disorder, the specific act potential may be changed to “alerting” or “dangerous” even though conversation between the another user 510 and the young child 520 corresponds to normal conversation. Alternatively, if the young child is extrovert and full of curiosity, the specific act potential may be determined as being safe despite direct physical contact between the another user 510 and the young child 520.

In an embodiment, the self-driving vehicle is an example of a specific space and the user monitoring method may apply to a user in the specific space in which a monitoring target is present. Thus, the specific space may be a predetermined area in a building or may include a predetermined area regarding which image information and/or sound information can be acquired.

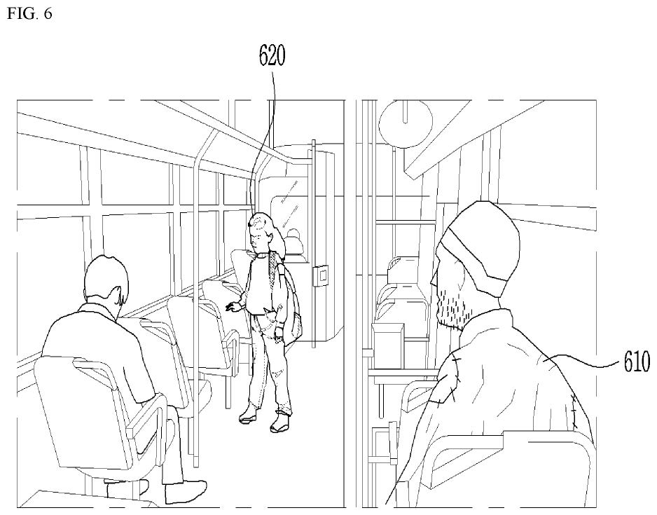

FIG. 6 is a diagram showing an example of a user monitoring method for determining a specific act potential for an occupant preset by another occupant present in a vehicle using a user monitoring apparatus according to yet another embodiment of the present invention. The above description about the user monitoring apparatus may apply to the user monitoring apparatus shown in FIG. 6.

At least one user may be present in the self-driving vehicle. At this point, a preset user may exist in users present in the vehicle. Here, the preset user may be a user designated in advance through an external server of the self-driving vehicle. For example, a parent may set a young child in advance through the external server and, in a case where the young child gets on the self-driving vehicle to go to school and go home after school, a sensor may recognize the young child. Here, the external server, which is a server for providing a service for estimating a specific act potential for a preset user, may transmit a notification to a designated user.

In the self-driving vehicle, another user may be present in addition to a preset user. At this point, most of other users present in the vehicle may be less likely to commit a crime against the preset user, but some of the users may be likely to commit a crime against the preset user.

Based on the image information and/or the sound information of an interior of the vehicle, which are acquired by the sensor, a processor embedded in the user monitoring apparatus may monitor information related to another user 610 present in the self-driving vehicle. Specifically, the processor may monitor outer appearance of the another user 610. Based on the outer appearance of the another user 610 monitored by the processor, the processor may determine a specific act potential for a user 620 (e.g., a young child) preset by the another user 610 using an interaction potential prediction module, and the user monitoring apparatus may perform a preset operation according to the determination. Here, the crime potential may be, but not limited thereto, information related to an actual felony and may include a potential to perform a specific act set by a user or a potential to perform a specific act associated with the young child. For example, if the parent presets the presence of a homeless-like user or a user with tattoo, the presence of the homeless person-like user or the user with tattoo within a predetermined distance from the young child 620 may be determined as a specific act potential.

At this point, the above description may apply to an operation according to the determination and change of the determined specific act potential. In an embodiment, predicting a crime based on a person's outer appearance may be performed based on a result of monitoring of statistical information by the processor.

Specifically, if the user monitoring apparatus determines the another user 610 present in the self-driving vehicle as homeless based on a cloth and/or face of the another user 610, the user monitoring apparatus may determine a specific act potential depending on a distance between the another user 610 and the young child 620. For example, if the homeless-like another user 610 is present in the vehicle and sitting within a predetermined distance from the young child 620, the user monitoring apparatus may estimate a specific act potential as “alerting” and may perform a preset operation corresponding to “alerting”. Alternatively, if the homeless-like another user 610 is present in the vehicle and sitting within the predetermined distance from the young child 620 and attempts to contact the young child 620, the user monitoring apparatus may estimate a specific act potential as “dangerous” and may perform a preset operation corresponding to “dangerous”.

In addition, if the user monitoring apparatus determines that the another user 610 present in the self-driving vehicle has tattoo, the user monitoring apparatus may determine a specific act potential based on a distance between the another user 610 and the young child 620 and/or whether the another user 610 changes his/her facial expression while gazing the young child 620 and/r whether the another user 610 takes a specific act while gazing at the young child 620. For example, whether the another user 610 with tattoo hardens his/her faces while gazing the young child 620 or makes a smile and/or whether the another user 610 takes a specific act (e.g., threatening) while gazing the young child 620 may be monitored and the user monitoring apparatus may perform preset operations corresponding to the respective cases.

In addition, the user monitoring apparatus may estimate a specific act potential based on impression of the another user 610 present in the self-driving vehicle. That is, when the user monitoring apparatus determine good or bad impression based on a facial expression of the another user 610 present in the self-driving vehicle, the user monitoring apparatus may differently estimate a specific act potential for the same behavior depending on the impression. For example, different specific act probabilities may be estimated for the same behavior when the another user 610 having good impression gazes the young child 620 and when the another user 610 having bad impression gazes the young child 620.

In addition, the user monitoring apparatus may determine a specific act potential by taking into consideration a previous record inquired through appearance of the another user 610. For example, the user monitoring apparatus may differently estimate specific act probabilities for the same behavior when the another user 610 having a crime record gazes the young child 620 and when the another user 610 having no crime record gazes the young child 610.

In an embodiment, the self-driving vehicle is an example of a specific space and the user monitoring method may apply to a user in the specific space in which a monitoring target is present. Thus, the specific space may be a predetermined area in a building or may include a predetermined area regarding which image information and/or sound information can be acquired.

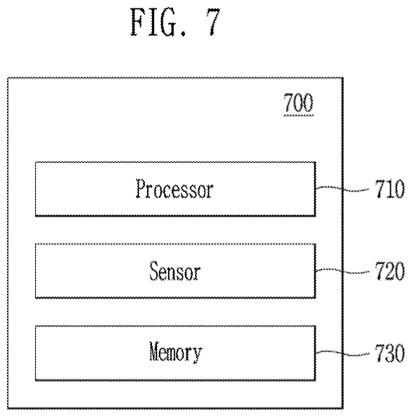

FIG. 7 is a block diagram of a user monitoring apparatus according to an embodiment of the present invention.

According to an embodiment of the present invention, a user monitoring apparatus 700 may include a processor 710, a sensor 720, and a memory 730. The user monitoring apparatus 700 may further include a communication unit (not shown) capable of transmitting and receiving data. The sensor 720 may be embedded in the user monitoring apparatus 700 or may be installed outside the user monitoring apparatus 700, and, when the sensor 720 is installed outside the user monitoring apparatus 700, information monitored through the communication unit may be transmitted to the user monitoring apparatus 700. At this point, it is apparent to those skilled in the art that features and functions of the processor 710, the memory 730, and the communication unit (not shown) correspond to the processor 180, the memory 170, and the communication unit 110 shown in FIG. 1.

In general, the processor 710 may control overall operations of the user monitoring apparatus 700. For example, the processor 710 may control overall operations of the communication unit, the sensor, and the like by executing programs stored in the memory 720. In addition, the processor 710 may perform a combination of the functions of the user monitoring apparatus shown in FIGS. 4, 5, and 6 by executing programs stored in the memory 720.

In addition, the processor 710 may determine a specific act potential based on gaze-related information by tracking face and pupil of another user present in a self-driving vehicle and perform an operation corresponding to the determination. In addition, the processor 710 may determine a specific act potential by analyzing a language used by the another user present in the self-driving vehicle and perform an operation corresponding to the determination. In addition, the processor 710 may determine a specific act potential by analyzing outer appearance of the another user present in the self-driving vehicle and perform an operation corresponding to the determination. In addition, the processor 710 may inquire a previous record (e.g., a crime record) through the face of the another user present in the self-driving vehicle, determine a specific act potential according to the previous record, and perform an operation corresponding to the determination.

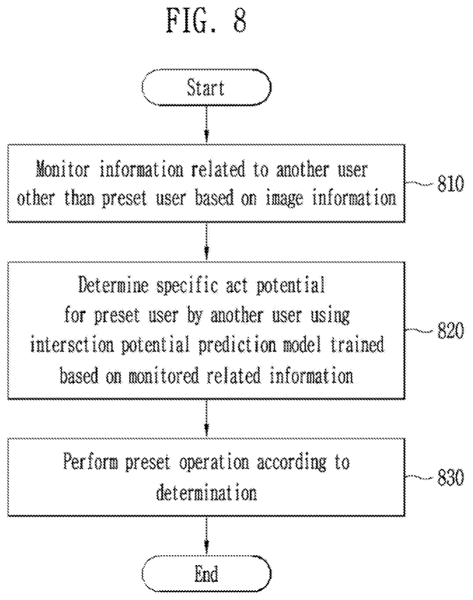

FIG. 8 is a flowchart of a user monitoring method by use of a user monitoring apparatus according to an embodiment of the present invention.

In step 810, a user monitoring apparatus may acquire image information of the interior of a self-driving vehicle, and monitor information related to another user in addition to a preset user present in the self-driving vehicle based on the acquired image information. Here, the monitored related information may include the number of times the another user gazes the young child or an increase/decrease in a time period in which the another user gazes the young child. In addition, the monitored related information may indicate a frequency of a swear word included in a language used by the another user or whether information on a young child is included in the language used by the another user. In addition, the monitored related information may indicate outer appearance of the another user and may indicate a previous record inquired through the face of the another user.

At this point, a start point and a destination of the young child present in the self-driving vehicle may be determined in advance, and, when the self-driving vehicle arrives nearby the destination, a notification indicative of getting off may be transmitted to the young child and the parent.

In step 820, the user monitoring apparatus may determine a specific act potential for a user set by the another user using an interaction potential prediction model that is trained based on the monitored related information. Here, the interaction potential prediction model may be trained in advance through a Deep Neural Network (DNN), which is an example of deep learning, and may be updated based on the monitored related information.

At this point, the user monitoring apparatus may change the estimated specific act potential by reflecting interaction between the another user and the preset user (e.g., a young child). For example, when the another user contacts the young child, a specific act potential may be determined as “alerting” or “dangerous”, and, when a result of analysis of conversation between the another user and the young child shows that the conversation is normal conversation, the specific act potential may be changed to be safe. However, even though the conversation corresponds to normal conversation, if the another user contacts the young child or interaction between them lasts for a predetermined time, the specific act potential may be changed to be “alerting” or “dangerous”.

In addition, the user monitoring apparatus may change a specific act potential according to the interaction by reflecting information related to the present user (e.g., the young child). For example, in a case where the young child is introvert or has a social anxiety disorder, if conversation between the another user and the young child corresponds to normal conversation, the specific act potential may be changed to be “alerting” or “dangerous”. Alternatively, if the young child is extrovert and full of curiosity, the specific act potential may be determined to be safe despite direct physical contact between the another user and the young child.

In addition, the user monitoring apparatus may change a specific act potential according to interaction, by taking into consideration a previous record (e.g., a crime record) inquired through face of the another user present in the self-driving vehicle. For example, even though the young child and the another user are having normal conversation, if the another user has a previous record, the specific act potential may be determined as “alerting” or “dangerous” rather than “safe”.

Here, a type and/or probability of the specific act potential may differ according to information monitored with respect to the young child and another user. For example, when the another user attempts to contact the young child while gazing the young child constantly, the specific act potential may be determined as “alerting” at a probability of 60%, or, when a language used by another user having a crime record includes a word such as “kidnapping” and “abduction” about the young child, the specific act potential may be determined as “dangerous” at a probability of 90%.

In step 830, the user monitoring apparatus may perform a preset operation according to the determination of the specific act potential.

If the specific act potential is determined as safe, the user monitoring apparatus may not transmit a notification to the designated user. For example, if the another occupant other than the young child is monitored and thereby a specific act potential for the young child by the occupant is determined as safe at a probability of 70%, the user monitoring apparatus may not transmit a notification to the parent.

Alternatively, if the specific act potential is determined as “alerting”, the user monitoring apparatus may transmit a notification to a designated user (e.g., the young child and the parent) or may induce transit to another self-driving vehicle. At this point, the user monitoring apparatus may induce the young child to transit, by taking into consideration a travel distance/travel time/available transportation for the young child to reach a destination. If the another occupant transits to a different self-driving vehicle into which the young child has transited, the user monitoring apparatus may display a notification corresponding to “dangerous” in order to ask for help from people around. For example, if the number of times another occupant with tattoo gazes the young child and/or a time period in which another occupant with tattoo gazes the young child is compared with a predetermined reference and thereby a specific act potential is determined as “alerting” at a probability of 60%, the user monitoring apparatus may transmit a notification to the designated user and may, at the same time, guide transit to a different self-driving vehicle by taking into consideration a travel distance/travel time/available transportation to reach the young child's preset destination (e.g. a school). If the another user transits to the self-driving vehicle to which the young child has transited, the user monitoring apparatus may display, on a nearby display, a notification corresponding to “dangerous” in order to ask for help from nearby people.

In another example, if another occupant gets on the vehicle with a cat, in order to protect a young child allergic to cats, the user monitoring apparatus may transmit a notification to a designated user and may, at the same time, guide the young child to transit to a different self-driving vehicle based on information related to hospitals/pharmacies in the surroundings of a preset destination.

Alternatively, if a specific act potential is determined as “dangerous”, the user monitoring apparatus may perform a preset operation corresponding to “dangerous”. In an example of the preset operation corresponding to “dangerous”, the user monitoring apparatus may displays “dangerous” through an internal/external display of the self-driving vehicle while transmitting a notification not just to a designated user (e.g., a young child and a parent) but also to a police station and the self-driving vehicle, may induce transit to a different self-driving vehicle, or change the young child's destination to a safe place. If another occupant transits to the different self-driving vehicle to which the young child has transited, the user monitoring apparatus may display, on a nearby display, a notification corresponding to “dangerous” in order to ask for help from nearby people.

For example, if a language used by another user having a crime record contains a word such as “kidnapping” and “abduction” regarding a young child, the user monitoring apparatus may determine a specific act potential as “dangerous” at a probability of 90%. At this point, the user monitoring apparatus may transmit a notification to a designated user and, at the same time, change the young child's destination to a safe place. Here, the safe place may be a police station or a bustling place that is preset based on a statistical record. Alternatively, the user monitoring apparatus may transmit a notification to the designated user and may, at the same time, guide transit to a different self-driving vehicle by taking into consideration a travel distance/travel time/available transportation to reach the young child's preset destination (e.g. a school). If the another user transits to the self-driving vehicle to which the young child has transited, the user monitoring apparatus may display, on a nearby display, a notification corresponding to “dangerous” in order to ask for help from nearby people.

In another example, in a case where a young child is severely allergic to a specific animal, if the specific animal gets on the self-driving vehicle, the user monitoring apparatus may display, on a display, a notification regarding emergency treatment of the young child.

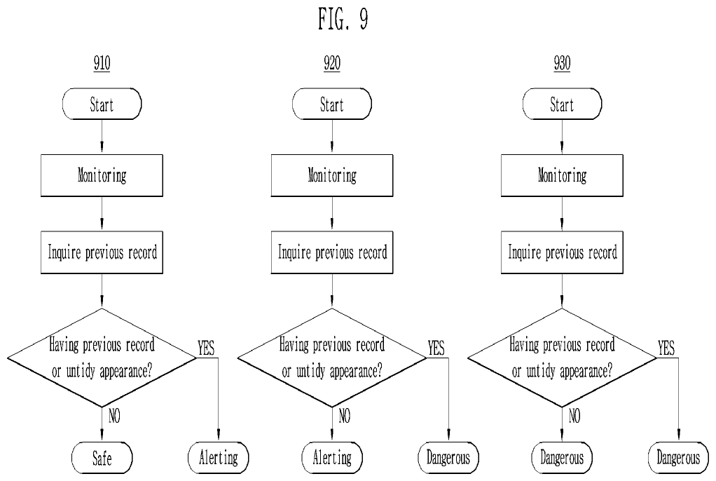

FIG. 9 is a diagram showing how to change a specific act potential depending on a previous record and outer appearance of another user other than a preset user according to an embodiment of the present invention.

A drawing 910 shows a case where a specific act potential is “safe”, for example, a case where another user gets on a vehicle and takes a normal act (e.g., using a user terminal, listening to music, viewing surrounding scenery, having a regular talk with another passenger, etc.). A processor ma monitor may monitor information related to the another user present in a vehicle, and a user monitoring apparatus may inquire a previous record using a face of the monitored another user. At this point, the user monitoring apparatus may inquire the previous record and/or change a specific act potential determined based on outer appearance of the monitored another user. For example, in a case where the another user gets on the vehicle and perform a normal act, the user monitoring apparatus may determine the specific act potential as “safe” unless the another user has no previous record, has no tattoo or does not look like homeless. Alternatively, even in a case where the another user present in the vehicle has a previous record or even has no previous record, if the another user looks like homeless, the user monitoring apparatus may change the specific act potential to “alerting”.

A drawing 920 shows a case where a specific act potential is “alerting”, for example, a case where another user gets on a vehicle and keeps speaking swear words or gazing at a young child. The processor may monitor information related to the another user present in the vehicle and may inquire a previous record using face of the monitored another user. At this point, the user monitoring apparatus may inquire the previous record and/or change a specific act potential determined based on outer appearance of the monitored another user. For example, in a case where the another user gets on the vehicle and keeps speaking swear words or gazing at the young child, the user monitoring apparatus may estimate the specific act potential as “alerting” unless the another user has no previous record, has no tattoo or does not look like homeless. Alternatively, even in a case where the another user present in the vehicle has a previous record or even has no previous record, if the another user has tattoo or looks like homeless, the user monitoring apparatus may change the specific act potential to “dangerous”.

A drawing 930 shows a case where a specific act potential is “dangerous”, for example, a case where another user gets on a vehicle and contacts with a young child. Here, the contact may mean a specific act such as a threat toward the young child by the another user. The processor may monitor information related to the another user present in the vehicle and may inquire a previous record of the another user using face of the monitored another user. At this point, the user monitoring apparatus may inquire the previous record of the another user and/or change a specific act potential determined based on outer appearance of the another user. For example, in a case where the another user gets on the vehicle and attempts to contact the young child, the user monitoring apparatus may determine the specific act potential as “dangerous” as long as the another user has no tattoo or does not look like homeless even though the another user has no previous record, or, even in a case where the another user present in the vehicle has a previous record or in a case where the another user has tattoo or looks like homeless even though the another user has no previous record, the user monitoring apparatus may determine the specific act potential as “dangerous”.

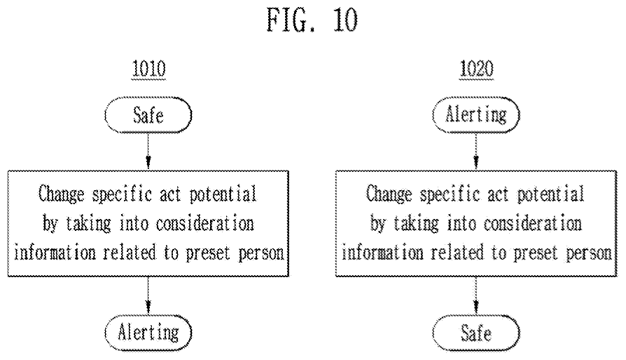

FIG. 10 is a diagram showing how to change a specific act potential by reflecting information related to a preset user according to an embodiment of the present invention.

A drawing 1010 shows a case where a specific act potential determined as “safe” is changed to “dangerous” when information related to a preset user (e.g., a young child) is considered. For example, if the young child is introvert or has a social anxiety disorder, the user monitoring apparatus may determine a specific act potential as “alerting” even though conversation between another user and the young child in a predetermined area corresponds to normal conversation, and then the user monitoring apparatus may perform a corresponding operation.

A drawing 1020 shows a case where a specific act potential determined as “alerting” is changed to “safe” when information related to a preset user (e.g., a young child) is considered. For example, if the young child is extrovert and full of curiosity, the user monitoring apparatus may determine a specific act potential as “safe” even though contact between an user and thee young child occurs, and then the user monitoring apparatus may perform a corresponding operation.

The aforementioned embodiments described a method of monitoring an occupant inside a vehicle (e.g., a self-driving vehicle), but the method is not limited to the occupant inside the vehicle and it is apparent that the method can apply to users in a specific space to be monitored. In the embodiment, the specific space may be a predetermined area in a building or may include a predetermined area regarding which image information and/or sound information can be acquired.

In the aforementioned embodiment, an external server for providing a service to determine a specific act potential for a preset user may determine a frequency of notification in consideration of schedule of a designated user and usage of communication data. For example, the external server, which provides a service to monitor a young child's going to school and going home after school may transmit a notification in consideration of schedule of a parent and usage of communication data.

In addition, in the aforementioned embodiment, information related to a preset user may include information such as allergy to animals. At this point, in a case where another user is an animal and the animal is located within a predetermined distance from the animal, the user monitoring apparatus may request ventilation of the self-driving vehicle or may transmit information related to hospitals/pharmacies in the surroundings of a destination to a designated user.

The terms or words described in the description and the claims should not be limited by a general or lexical meaning, instead should be analyzed as a meaning and a concept through which the inventor defines and describes the invention to the best of his/her ability, to comply with the idea of the invention. Therefore, one skilled in the art will understand that the embodiments disclosed in the description and configurations illustrated in the drawings are only preferred embodiments, instead there may be various modifications, alterations, and equivalents thereof to replace the embodiments at the time of filing this application. For example, suitable results may be achieved if the described techniques are performed in a different order, and/or if components in a described system, architecture, device, or circuit are combined in a different manner, and/or replaced or supplemented by other components or their equivalents.

What is claimed is:

1. A user monitoring method performed by a computing device, the method comprising:
acquiring image information of an interior of a self-driving vehicle;
monitoring information related to another user other than a preset user in the self-driving vehicle based on the acquired image information;
determining a specific act potential for the preset user by the another user using an interaction potential prediction model trained based on the monitored related information; and
performing a preset operation according to the determination of the specific act.

2. The method of claim 1, wherein the performing of the preset operation comprises, according to the determination of the specific act potential, changing a destination of the preset user, inducing of the preset user to transit to a different self-driving vehicle, or displaying a notification for asking help from people around the preset user.

3. The method of claim 1, wherein the determining of the specific act potential comprises changing the determined specific act potential by reflecting interaction between the another user and the preset user.

4. The method of claim 3, wherein the changing of the specific act potential determined by reflecting the interaction comprises changing the determined specific act potential according to the interaction by reflecting the information related to the preset user.

5. The method of claim 3, wherein the changing of the specific act potential determined by reflecting the interaction comprises changing the determined specific act potential according to the interaction in consideration of a previous record of the another user.

6. The method of claim 1, wherein the monitored related information comprises information related to an increase or decrease in a number of times the another user gazes the preset user or an increase or decrease in time for which the another user gazes the preset user.

7. The method of claim 1, further comprising acquiring sound information,
wherein the monitored related information comprises at least one of the following: a frequency of a swear word included in a language used by the another user, which is determined based on the sound information, and whether information on the another user is included in the language used by the another user.

8. The method of claim 1, wherein the monitored related information comprises outer appearance of the another user.

9. The method of claim 1, wherein the monitored related information comprises a previous record that is inquired through face of the another user.

10. The method of claim 1, wherein the interaction potential prediction model is updated based on the monitored related information.

11. The method of claim 1, wherein the computer readable non-volatile recording medium records instructions for implementing in a computer.

12. A user monitoring apparatus, comprising:
a sensor configured to acquire image information; and
a processor configured to monitor information related to another user related to a preset user based on the acquired image information, determine a specific act potential for the preset user by the another user using an interaction potential prediction model trained based on the monitored related information, and perform a preset operation according to the determination of the specific act potential.

13. The apparatus of claim 12, wherein the processor is configured to, according to the determination of the specific act potential, change a destination of the preset user, induce of the preset user to transit to a different self-driving vehicle, or display a notification for asking help from people around the preset user.

14. The apparatus of claim 12, wherein the processor is configured to change the determined specific act potential by reflecting interaction between the another user and the preset user.

15. The apparatus of claim 14, wherein the processor is configured to change the determined specific act potential according to the interaction by reflecting the information related to the preset user.

16. The apparatus of claim 14, wherein the processor is configured to change the determined specific act potential according to the interaction in consideration of a previous record of the another user.

17. The apparatus of claim 12, wherein the related information monitored by the sensor comprises information related to an increase or decrease in a number of times the another user gazes the preset user or an increase or decrease in time for which the another user gazes the preset user.

18. The apparatus of claim 12,
wherein sound information is acquired, and
wherein the monitored related information comprises at least one of the following: a frequency of a swear word included in language used by the another user, which is determined based on the sound information, and whether information on the another user is included in the language used by the another user.

19. The apparatus of claim 12, wherein the monitored related information comprises outer appearance of the another user.

20. The apparatus of claim 12, wherein the monitored related information comprises a previous record that is inquired through face of the another user.
